(19) United States
(12) Patent Application Publication
(10) Pub. No.: US 2005/0012848 A1
(43) Pub. Date: Jan. 20, 2005

(54) Image quality adjustment

(76) Inventor: Ikuo Hayaishi, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/621,264

(22) Filed: Jul. 15, 2003

(30) Foreign Application Priority Data
Jul. 14, 2003 (JP) 2003-196284(P)

(51) Int. Cl. H04N 9/68; H04N 5/222

(52) U.S. Cl. 348/371; 348/234

(57) ABSTRACT

A first image processing device executes brightness value adjustment of image data generated by an image generator, using at least either of: image generation record information that is associated with the image data and that includes at least flash information for a supplementary light source at the time of generation of the image data, and the size of an area of linked pixels having brightness above a first predetermined brightness value in the image data is larger than a predetermined threshold value. A second image processing device, when a judgment that the size of an area of linked pixels having brightness above a first predetermined brightness value in image data generated by an image generator is larger than a predetermined threshold value is realized, executes image quality adjustment processing to adjust the image data such that variation in brightness value is minimized in the highest value range within an entire possible range for brightness value represented by the image data.

### BACKGROUND OF THE INVENTION

1. Field of the Invention

The present invention relates to an image quality adjustment technique for adjusting image data.

2. Description of the Related Art

The quality of image data generated by a digital still camera (DSC), digital video camera (DVC) or the like can be adjusted as desired using an image retouching application on a personal computer. An image retouching application is typically equipped with an image adjusting function for automatically adjusting the quality of image data; by using this image adjusting function, the quality of an image output by an output device can be improved. CRTs, LCDs, printers, projectors, and television receivers, for example, are known as image output devices.

A printer driver, which controls the operation of one of these output devices, namely, a printer, is also equipped with a function for automatically adjusting image quality, and the quality of printed images can be improved using such a printer driver as well.

However, the automatic image quality adjusting function provided by an image retouching application or printer driver executes image quality correction suitable for image data having standard image characteristics. On the other hand, image data being subjected to image processing can be produced under various conditions, so in some instances image quality cannot be improved by executing a same given automatic image quality adjusting function.

For example, where a physical object, landscape, person, video image or other subject being photographed is dark, a method of producing a flash or other supplementary light source in order to illuminate the subject is frequently employed. If the amount of light on the subject from the supplementary light source is greater than the proper amount, so-called “whiteout” areas that are highly bright and appear white may occur in portions of the image obtained from the image data so produced. These whiteout areas are highly bright and tend to stand out relative to other areas; however, it is not intentional that these whiteout areas stand out. When an image containing such a whiteout area is subjected to image correction suitable for image data having standard image characteristics, overall image quality will not be improved in some instances. This problem is not limited to DSCs, and is a problem common to DVCs and other such image producing devices.

### SUMMARY OF THE INVENTION

The present invention has as an object to carry out appropriate automatic adjustment of image quality depending on the individual set of image data.

In order to attain at least part of the aforementioned object, the first image processing device according to this invention performs image processing using image data generated by an image generator, and image generation record information that is associated with the image data and that includes at least flash information for a supplementary light source at the time of generation of the image data. The device comprises an image quality adjuster that, on the basis of flash information for the supplementary light source included in the image generation record information, makes a decision as to whether to execute image quality adjustment processing; and in the event of making a decision to perform processing, executes image quality adjustment processing to adjust the image data such that variation in brightness values is minimized in the highest value range within the range of possible values for brightness values represented by the image data.

This first image processing device can, on the basis of flash information for the supplementary light source at the time of image generation, appropriately decide whether to execute image quality adjustment processing. It can also execute image quality adjustment so as to minimize variation in brightness values in the highest value range of brightness values, thereby preventing areas of high brightness from standing out.

The second image processing device according to this invention performs image processing using image data generated by an image generator. The device comprises an image quality adjuster that, upon making a decision that the size of an area of linked pixels having brightness above a first predetermined brightness value in the image data is larger than a predetermined threshold value, executes image quality adjustment processing to adjust the image data such that variation in brightness values is minimized in the highest value range within the range of possible values for brightness values represented by the image data.

This second image processing device can, on the basis of the size of an area of linked pixels having brightness above a first predetermined brightness value, appropriately decide whether to execute image quality adjustment processing. It can also execute image quality adjustment so as to minimize variation in brightness values in the highest value range in the range of possible brightness values represented by the image data, thereby preventing areas of high brightness from standing out.

It is also possible to realize this invention in various modes, for example, an image output method and image output device; an image data processing method and image data processing device; a computer program for realizing functions of such a method or device; a storage medium having such a computer program stored thereon; and a data signal embedded in a carrier wave containing such a computer program and represented.

These and other objects, features, embodiments, and advantages of the present invention will be apparent from the following description of the preferred embodiments set forth hereinbelow together with drawings.

### BRIEF DESCRIPTION OF THE DRAWINGS

FIG. 1 is a block diagram showing the arrangement of an image output system as an embodiment of the invention.

FIG. 2 is a block diagram showing a simplified arrangement of a digital still camera 12.

FIG. 3 is an explanatory diagram conceptually illustrating an example of an arrangement within an image file that can be used in this embodiment.

FIG. 4 is an explanatory diagram describing an example of data structure of an ancillary information storage field 103.

FIG. 5 is an explanatory diagram describing an example of data structure in an Exif data field.

FIG. 6 is a block diagram showing a simplified arrangement of a printer 20.

FIG. 7 is a block diagram showing an arrangement of printer 20, centered on the control circuit 30 of printer 20.

FIG. 8 is a flowchart showing a process flow for generating a image file GF in digital still camera 12.

FIG. 9 is a flowchart showing a processing routine for image processing in printer 20.

FIG. 10 is a flowchart showing a processing routine for image processing based on image generation record information.

FIG. 11 is a flowchart showing a processing routine for automatic image quality adjustment processing.

FIG. 12 is an explanatory diagram showing the relationship between brightness value input level and output level in an embodiment of automatic image quality adjustment processing.

FIG. 13 is an explanatory diagram showing the relationship between first predetermined value and flash intensity in an embodiment of automatic image quality adjustment processing.

FIG. 14 is an explanatory diagram showing the relationship between first predetermined value and flash intensity in another embodiment of an automatic image quality adjustment processing.

FIG. 15 is an explanatory diagram showing the relationship between first predetermined value and F number in an embodiment of automatic image quality adjustment processing.

FIG. 16 is an explanatory diagram showing the relationship between first predetermined value and ISO speed rating in an embodiment of automatic image quality adjustment processing.

FIG. 17 is an explanatory diagram describing an example of a whiteout area in an image. FIG. 18 is an explanatory diagram describing an example of a whiteout area and image quality adjustment process target area in an image.

FIG. 19 is an explanatory diagram showing the relationship between brightness value input level and output level in another embodiment of automatic image quality adjustment processing.

FIG. 20 is an explanatory diagram showing the relationship between brightness value input level and output level in another embodiment of automatic image quality adjustment processing.

FIG. 21 is an explanatory diagram showing an example of an image output system in which a image data processing device may be implemented.

FIG. 22 is a flow chart showing an image processing routine from which the color space conversion process has been omitted.

FIG. 23 is a flowchart showing another processing routine for image processing based on image generation record information.

FIG. 24 is a flowchart showing another processing routine for image processing based on image generation record information.

### DESCRIPTION OF THE PREFERRED EMBODIMENTS

Output image adjustment of image files according to the present invention is described hereinbelow through certain preferred embodiments in the following order, making reference to the accompanying drawings.
A. Arrangement of Image Output System
B. Arrangement of Image File
C. Arrangement of Image Output System Capable of Using Image File
D. Image Processing in Digital Still Camera
E. Image Processing in Printer
F. Embodiments of Automatic Image Quality Adjustment Process
G. Arrangement of Image Output System Employing Image data Processing Device
H. Variant Examples

### A. Arrangement of Image Output System

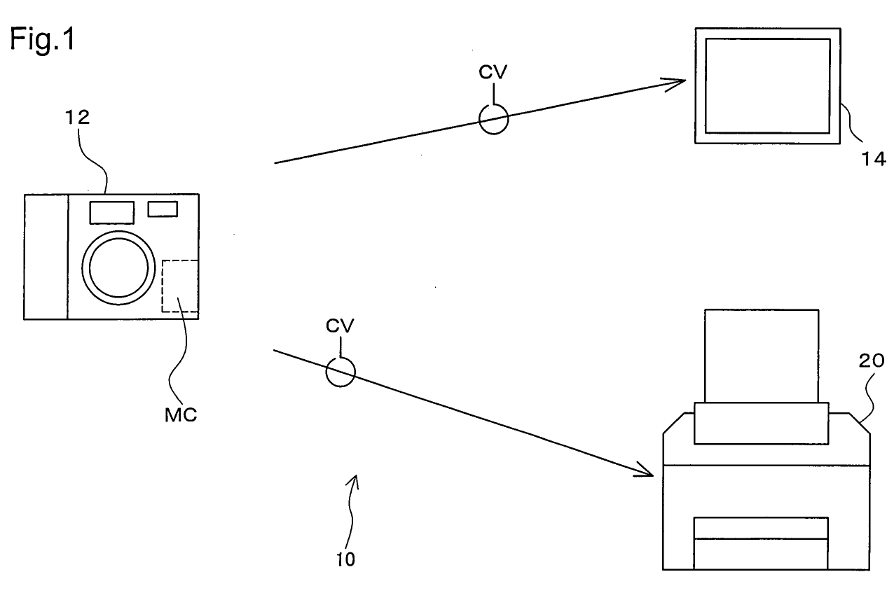

FIG. 1 is a block diagram showing the arrangement of an image output system as an embodiment of the invention. Image output system 10 comprises a digital still camera 12 as an image generating device for generating image files; and a printer 20 as an image output device. Image files generated by digital still camera 12 are transferred to printer 20 via a cable CV, or by directly inserting into printer 20 a memory card MC on which image files are stored. Printer 20 executes image quality adjustment processing of image data based on read out image files, and outputs the images. As the output device, a CRT display, LCD display, or other monitor 14, a projector, or the like could be used in addition to or instead of printer 20. The following description is based on the use of a printer 20 as the output device comprising an image quality adjuster and an image output section, with a memory card MC being inserted directly into the printer 20.

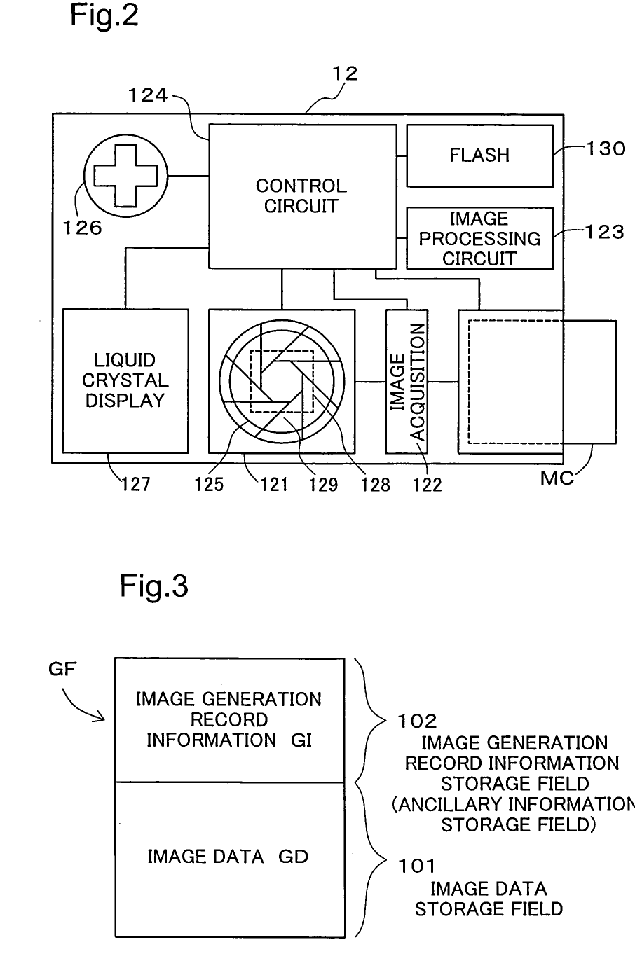

FIG. 2 is a block diagram showing a simplified arrangement of a digital still camera 12. The digital still camera 12 of this embodiment comprises an optical circuit 121 for capturing optical information; an image acquisition circuit 122 for controlling the optical circuit to acquire an image; an image processing circuit 123 for processing acquired digital images; a flash 130 serving as a supplemental light source; and a control circuit 124 for controlling the various circuits. Control circuit 124 comprises memory, not shown. Optical circuit 121 comprises a lens 125 for collecting optical information; an aperture 129 for adjusting the amount of light; and a CCD 128 for converting optical data passing through the lens into image data.

In this embodiment, optical circuit 121 and image acquisition circuit 122 correspond to the “image generator” in the invention.

Digital still camera 12 stores acquired images on a memory card MC. The typical storage format of image data in digital still camera 12 is the JPEG format, but other storage formats, such as TIFF format, GIF format, BMP format, or RAW data format could be used.

Digital still camera 12 comprises a Select/Set button 126 for setting various shooting parameters (aperture value, flash mode, ISO speed, shooting mode, etc.); and a liquid crystal display 127. Liquid crystal display 127 is used to preview photographed images, and when setting the aperture or other parameters using the Select/Set button 126.

Aperture value may be set to values within a range predetermined with reference to the model of digital still camera 12; for example, it may be set to certain predetermined discrete numbers from 2 to 16 (e.g., 2, 2.8, 4, 5.6 . . . etc.). F number is used for aperture value. Accordingly, a larger aperture value means a smaller aperture.

Flash mode is a parameter that controls operation of the flash 130, and can be selected from among auto flash mode, flash off mode, compulsory flash mode, etc., for example.

ISO speed rating is a parameter that relates to the sensitivity of optical circuit 121. ISO speed rating can be set to values within a certain predetermined range, for example, predetermined discrete values from 100 to 800 (e.g., 100, 200, 400, 800 etc.). ISO speed rating is originally an indicator of sensitivity of silver salt film; it is used in combination with other parameters relating to image generation, such as aperture value, to set appropriate image generating parameters (shooting parameters). In a digital still camera, by using the corresponding ISO speed rating as an indicator of the sensitivity of the optical circuit, image generating parameters such as aperture value can be set easily.

Shooting mode (scene mode) can be selected from among a number of predetermined modes such as standard mode, portrait mode, landscape mode, night scene mode, etc. Where one of these shooting modes has been set, related parameters (aperture value, ISO speed rating, flash mode, etc.) are set automatically depending on the set mode. For example, where standard mode has been selected as the shooting mode, parameters relating to image generation are set to standard values.

When a photograph has been taken with a digital still camera 12, image data and image generation record information are stored as a image file in memory card MC. Image generation record information can include aperture value and other parameter settings at the time of shooting (time of generation of image data) as described later in detail.

### B. Arrangement of Image File

FIG. 3 is an explanatory diagram conceptually illustrating an example of an arrangement within an image file that can be used in this embodiment. Image file GF comprises a image data storage field 101 for storing image data GD; and a image generation record information storage field 102 for storing image generation record information GI. Image data GD is stored, for example, in JPEG format, while image generation record information GI is stored, for example, in TIFF format (a format in which data and data fields are specified using tags). The terms file structure and data structure in this embodiment refer to file or data structure in the form in which a file or data etc. is stored in a memory device.

Image generation record information GI is information relating to an image when image data is generated (shot) by digital still camera 12 or other such image generating device, and includes the following settings.
flash (flash on/off)
subject distance
subject distance range
flash intensity
aperture value
ISO speed rating (ISO sensitivity)
shooting mode
maker name
model name
gamma value

The image file GF in this embodiment may comprise a image data storage field 101 and a image generation record information storage field 102; or may have a file structure according to an existing standardized file format. The following specific description pertains to the case where the image file GF pertaining to this embodiment conforms to the Exif file format.

An Exif file has a file structure in accordance with the digital still camera image file format specification (Exif); the specification has been proposed by the Japan Electronics and Information Technology Industries Association (JEITA). Similar to the conceptual diagram in FIG. 3, the Exif file format comprises a JPEG image data storage field for storing image data in the JPEG format; and an ancillary information storage field for storing information of various kinds relating to stored JPEG image data. The JPEG image data storage field corresponds to the image data storage field 101 in FIG. 3, and the ancillary information storage field to the image generation record information storage field 102. The ancillary information storage field stores image generation record information relating to a JPEG image, such as shooting date/time, aperture value, and subject distance.

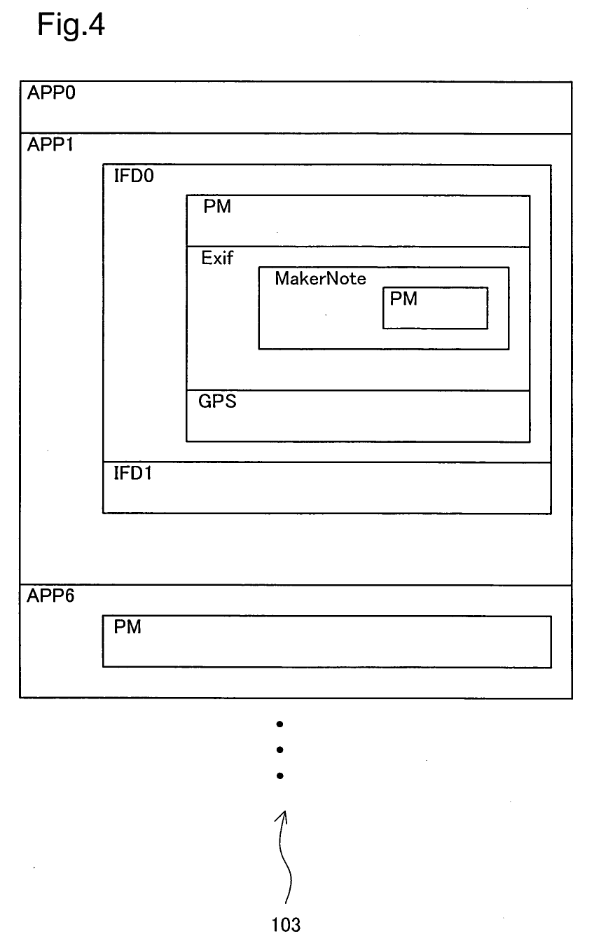

FIG. 4 is an explanatory diagram describing an example of data structure of ancillary information storage field 103. In the Exif file format, hierarchical tags are used to designate data fields. Each data field contains within it a plurality of subordinate data fields identified by subordinate tags. In FIG. 4, areas enclosed by rectangles represent single data fields, with tag names noted at upper left. In this embodiment, three data fields whose tag names are APP0, APP1, and APP6 are contained. The APP1 data field contains within it two data fields whose tag names are IFD0 and IFD1. The IFD0 data field contains three data fields whose tag names are PM, Exif, and GPS. Data and data fields are stored according to a prescribed address or offset value; address or offset value can be searched by means of tag name. On the output device end, data corresponding to desired information can be acquired by means of specifying and address or offset value corresponding to the desired information.

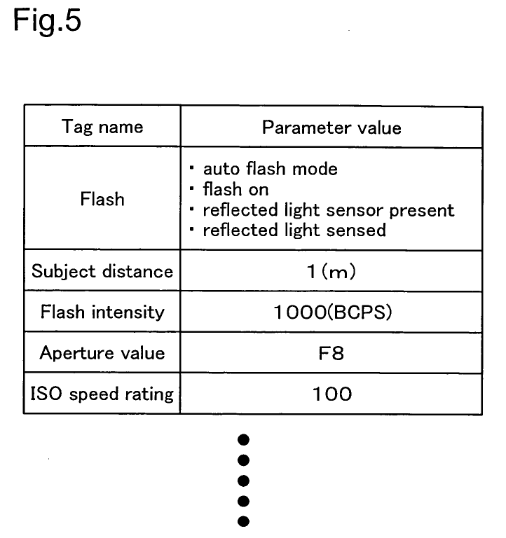

FIG. 5 is an explanatory diagram describing an example of data structure (data tag names and parameter values) in the Exif data field in FIG. 4, wherein tag name can be referenced by tracing in the order APP1-IFD0-Exif. As shown in FIG. 4, the Exif data field can include a data field whose tag name is MakerNote; the MakerNote data field can in turn include a plurality of items of data, although these are omitted in FIG. 5.

As shown in FIG. 5, the Exif data field stores parameter values relating to information such as flash on/off, subject distance, flash intensity, aperture value, and ISO speed rating, etc. In this example, flash on/off and flash intensity can be used as flash information for the supplemental light source. Flash intensity can also be used as information relating to the quantity of light of the supplemental light source. Subject distance is used as information relating to the distance between a subject and the image generating device; aperture value is used as information relating to aperture value; and ISO speed rating is used as information relating to the sensitivity of the optical circuit. It is sufficient for flash information relating to the supplemental light source to contain at least information for use in deciding whether or not there was illumination by the supplemental light source; for example, an arrangement in which flash on/off only is used as flash information for the supplemental light source is acceptable. Details of the decision as to whether or not there was illumination by the supplemental light source are described later.

Flash information is related to operation of the flash, and can include four pieces of information relating to operating mode and operation result thereof. Operating mode may be set from among a plurality of values including the following three values, for example.
1: compulsory flash mode
2: flash off mode
3: auto flash mode

Operation result may be set from among two values, Flash on or Flash off, for example. The decision as to whether or not there was illumination by the supplemental light source during generation of image data may be carried out using this operation result.

Some image generating devices are equipped with a mechanism for sensing reflected light from a subject illuminated with light from a flash. In the event that a flash cover or other obstacle blocks the flash light, or the flash does not fire despite being operated, no light illuminates the subject. Such instances can be identified through the presence or absence of reflected light. Flash information can include information relating to the presence/absence of a reflected light sensing mechanism, and to the presence/absence of reflected light sensed at the time the image data is generated at the time of shooting. In the event that a reflected light sensing mechanism is present and sensed reflected light is absent, it can be decided that there is no illumination by the supplemental light source, even if the aforementioned operation result is “Flash of.”

Subject distance information is related to the distance between the image generating device and a subject. For example, it can be set in meter units, based on distance information set to match the focal point at the time that image data is generated.

Flash intensity is related to the quantity of light emitted by the flash at the time that image data is generated; the unit of measurement thereof is BCPS (Beam Candle Power Seconds), for example.

ISO speed rating information is related to the sensitivity of the optical circuit, and is set to a parameter value equivalent to ISO speed which is an index of sensitivity of silver salt film.

Information associated with image data is also stored appropriately in fields other than the Exif data field in FIG. 4. For example, maker name and model name are stored in the data field whose tag name is IFD0, as information identifying the image generating device.

### C. Arrangement of Image Output System Capable of Using Image File

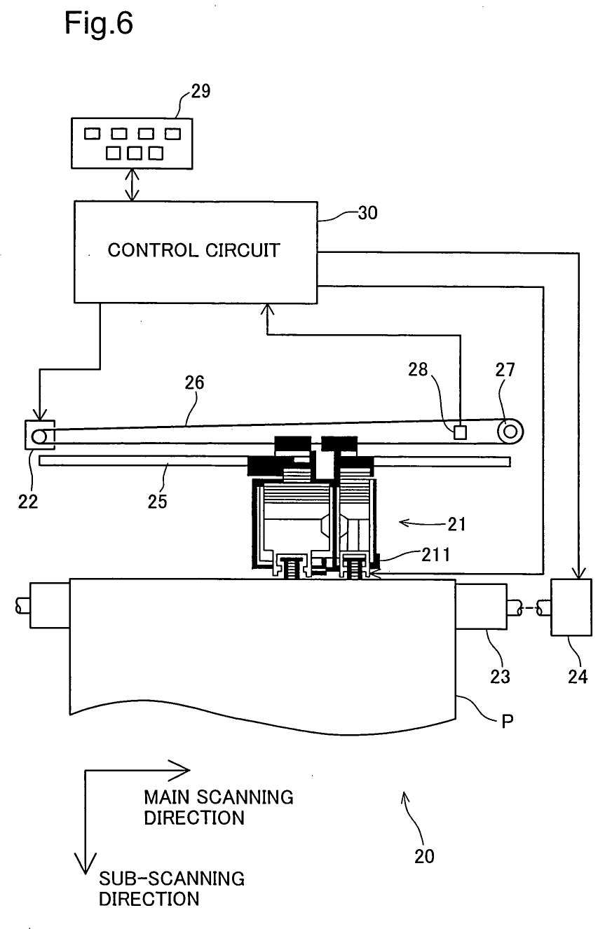

FIG. 6 is a block diagram showing a simplified arrangement of printer 20 in the present embodiment. Printer 20 is capable of image output, for example, an ink jet printer that ejects ink of four colors, cyan C, magenta Mg, yellow Y, and black K, on a print medium to produce dot patterns. An electrophotographic printer that transfers and fixes toner onto a print medium may also be used. In addition to the four colors indicated above, light cyan LC which is lighter in density than cyan C, light magenta LM which is lighter in density than magenta Mg, dark yellow DY which is darker in density than yellow Y may be used as ink. Where monochromatic printing is performed, the arrangement may employ black K only; or red R or green G may be used. The type of ink or toner used can be selected depending on the characteristics of the image for output.

As shown in the drawing, printer 20 comprises a mechanism for driving a print head 211 mounted on a carriage 21, to eject ink and form dots; a mechanism for reciprocating carriage 21 in the axial direction of a platen 23; a mechanism for feeding printer paper P by means of a paper feed motor 24; and a control circuit 30. By means of these mechanisms, printer 20 functions as an image output section. The mechanism for reciprocating carriage 21 in the axial direction of a platen 23 is composed of a slide rail 25 extending parallel to the axis of platen 23, for slidably retaining carriage 21; a pulley 27 coupled via an endless drive belt 26 to a carriage motor 22; and a position sensor 28 for sensing the home position of carriage 21. The mechanism for feeding printer paper P is composed of platen 23; paper feed motor 24 which rotates platen 23; an auxiliary paper feed roller, not shown in the drawing; and a gear train (not shown) for transmitting rotation of paper feed motor 24 to platen 23 and the auxiliary paper feed roller.

Control circuit 30 exchanges signals with a printer control panel 29 while appropriately controlling operation of paper feed motor 24, carriage motor 22, and print head 211. Printer paper P supplied to printer 20 is set pinched between platen 23 and the auxiliary paper feed roller, and advanced by a predetermined amount depending on the rotation angle of platen 23.

Carriage 21 has a print head 211, and enables mounting of an ink jet cartridge of utilizable ink. On the bottom face of print head 211 are disposed nozzles for ejecting utilizable ink (not shown).

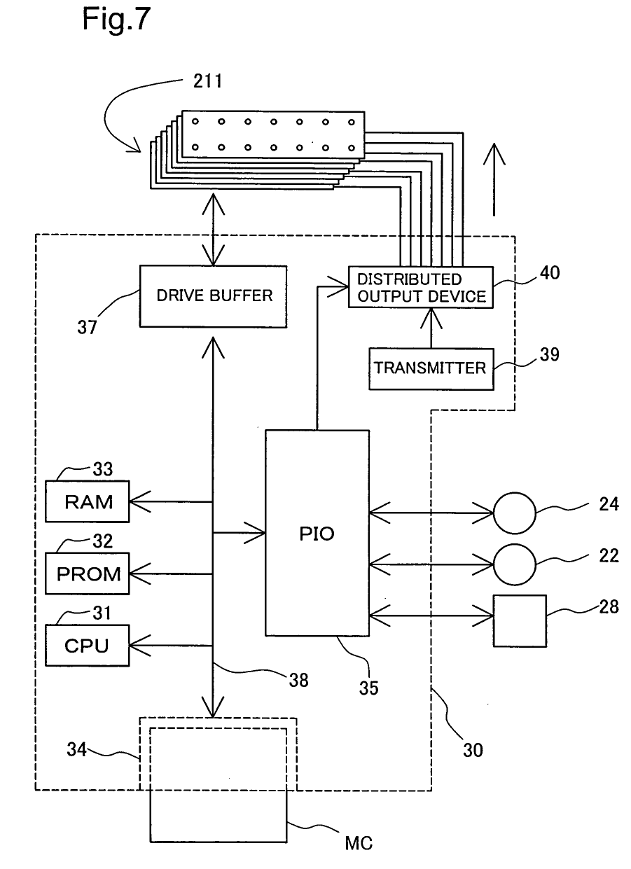

FIG. 7 is a block diagram showing an arrangement of printer 20, centered on the control circuit 30 of printer 20. Within control circuit 30 are disposed a CPU 31, PROM 32, RAM 33, a memory card slot 34 for acquiring data from a memory card MC, a peripheral device input/output section (PIO) 35 for exchanging data with paper feed motor 24, carriage motor 22, etc., a drive buffer 37, and the like. Drive buffer 37 is used as a buffer for supplying dot on/off signals to print head 211. These components are interconnected to a bus 38, enabling exchange of data among them. Control circuit 30 is also provided with a transmitter 39 for outputting a drive waveform at predetermined frequency, and a distributed output device 40 for distributing the output of transmitter 39 to print head 211 at predetermined timing.

Control circuit 30, while synchronizing with operations of paper feed motor 24 and carriage motor 22, outputs dot data to drive buffer 37 at predetermined timing. Control circuit 30 also reads image files from memory card MC, analyzes the ancillary information, and performs image processing based on the image generation record information acquired thereby. That is, control circuit 30 functions as an image quality adjuster. The flow of image processing executed by control circuit 30 will be described later in detail.

In the present embodiment, drive buffer 37, transmitter 39, distributed output device 40, and print head 211 function as an “image output section (or image forming section)” for outputting an image in response to image data. CPU 31 functions as a “data output section” for outputting quality-adjusted image data to the “image output section”.

### D. Image Processing in Digital Still Camera

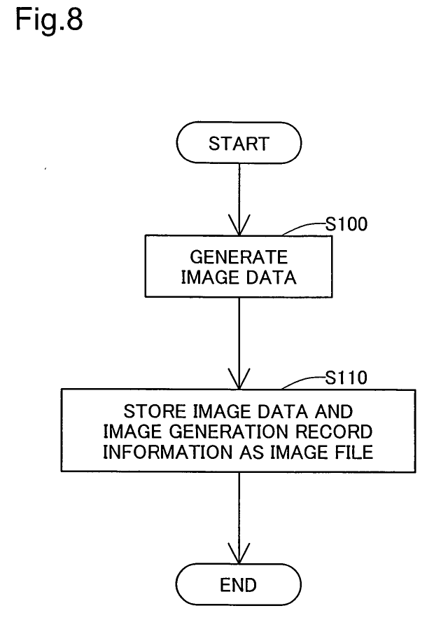

FIG. 8 is a flowchart showing a process flow for generating a image file GF in digital still camera 12.

Control circuit 124 (FIG. 2) of digital still camera 12 generates image data GD in response to a shoot request, for example, depression of a shutter button (Step S100). Where aperture value, ISO speed rating, shooting mode and other parameter settings have been made, image data GD is generated using the set parameter values.

Control circuit 124 stores the generated image data GD and image generation record information GI as a image file GF on memory card MC (Step S110), and terminates the processing routine. Image generation record information GI includes parameters used at the time of image generation, such as aperture value, ISO speed, etc.; shooting mode and/or other arbitrarily set parameter values; and parameter values set automatically, such as maker name, model name, and the like. Image data GD is also stored in the image data GF after being converted from the RGB color space to the YCbCr color space, and compressed in JPEG format.

By means of the aforementioned processes executed in digital still camera 12, both image data GD and image generation record information GI that includes various parameter values at the time of generation of image data is set in the image file GF stored on memory card MC.

### E. Image Processing in Printer

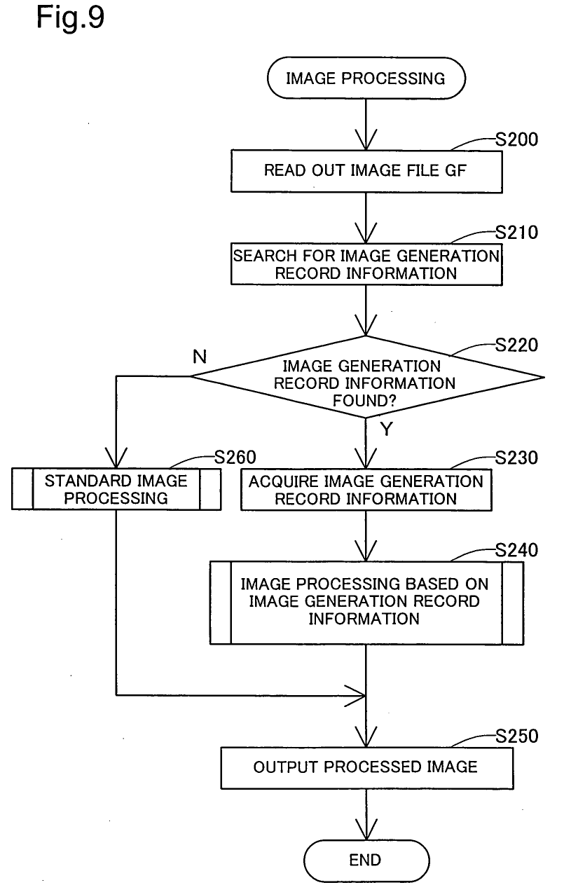

FIG. 9 is a flowchart showing a processing routine for image processing in printer 20 of the present embodiment. In the following description, the description is based on a case where a memory card MC having a image file GF stored thereon is inserted directly into printer 20. When memory card MC has been inserted into memory card slot 34, the CPU 31 of control circuit 30 (FIG. 7) of printer 20 reads out the image file GF from memory card MC (Step S200). Next, in Step S210, CPU 31 searches in the ancillary information storage field of image file GF for image generation record information GI indicating information at the time that the image data was generated. In the event that image generation record information GI is found (Step S220: Y), CPU 31 acquires and analyzes the image generation record information GI (Step S230). On the basis of the analyzed image generation record information GI, CPU 31 executes image processing, described later (Step S240), outputs the processed image (Step S250), and terminates the processing routine.

A image file created by a drawing application or the like, on the other hand, will not contain image generation record information GI having information such as aperture value and the like. If CPU 31 cannot find image generation record information GI (Step S200: N), it performs standard processing (Step S260), outputs the processed image (Step S250), and terminates the processing routine.

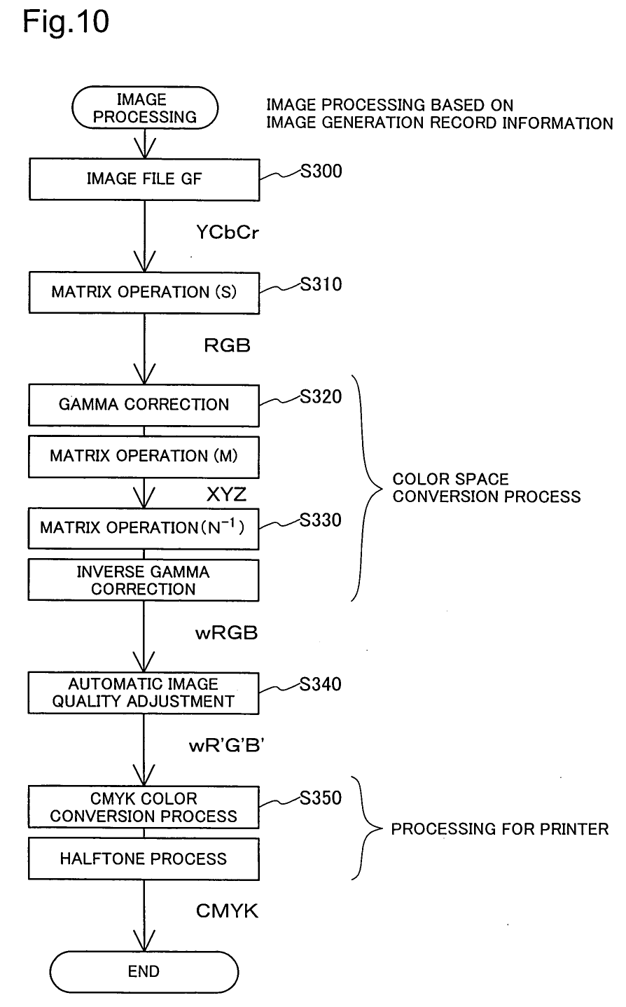

FIG. 10 is a flowchart showing a processing routine for image processing (corresponding to Step S240 in FIG. 9) based on image generation record information. The CPU 31 of control circuit 30 (FIG. 7) of printer 20 reads out image data GD from the read out image file GF (Step S300)

As mentioned previously, digital still camera 12 stores image data GD as JPEG format files, and in a JPEG format file image data is stored using an YCbCr color space. In Step S310, CPU 31 executes an operation using 3×3 matrix S to convert image data based on an YCbCr color space into image data based on an RGB color space. This matrix operation is represented by the following arithmetic expression, for example.

$$\begin{matrix}( \begin{matrix}R \\ G \\ B\end{matrix} ) = S ( \begin{matrix}Y \\ Cb - 128 \\ Cr - 128\end{matrix} ) \\ S = ( \begin{matrix}1 & 0 & 1.40200 \\ 1 & - 0.34414 & - 0.71414 \\ 1 & 1.77200 & 0\end{matrix} )\end{matrix} \qquad [ Eq . 1 ]$$

Where the color space of image data generated by digital still camera 12 is wider than a predetermined color space, for example, the sRGB color space, image data based on the RGB color space obtained in Step S310 may in some instances contain valid data that is outside the defined area of the RGB color space. Where image generation record information GI instructs this out-of-defined area data to be handled as valid data, the out-of-defined area data will be kept, and subsequent image processing continues. In the absence of an instruction to handle out-of-defined area data as valid data, out-of-defined area data is clipped to the defined area. For example, where the defined area is 0-255, negative value data of less than 0 is rounded to 0, and data above 255 to 255. In the event that the color space that is utilizable by the image output section is not wider than a predetermined color space, for example, the sRGB color space, it is preferably to clip to the defined area, regardless of any instruction in the image generation record information GI. Such instances would include, for example, cases where image is output to a CRT, whose available color space is the sRGB color space.

Next, in Step S320, CPU 31 performs gamma correction and an operation employing a matrix M, to convert image data based on an RGB color space to image data based on an XYZ color space. Image file GF can contain gamma value and color space information at the time of image generation. In the event that image generation record information GI includes this information, CPU 31 acquires the gamma value of the image data from the image generation record information GI, and executes a gamma conversion process of the image data using the acquired gamma value. CPU 31 then acquires color space information for the image data from the image generation record information GI, and executes a matrix operation of the image data using a matrix M that corresponds to the color space. In the event that image generation record information GI does not contain a gamma value, a gamma conversion process can be executed using a standard gamma value. A gamma value and matrix for the sRGB color space may be used respectively as this standard gamma value and matrix M. The matrix operation may be given by the following arithmetic expression, for example.

$$\begin{matrix}( \begin{matrix}X \\ Y \\ Z\end{matrix} ) = M ( \begin{matrix}{Rt}^{′} \\ {Gt}^{′} \\ {Bt}^{′}\end{matrix} ) \\ M = ( \begin{matrix}0.6067 & 0.1736 & 0.2001 \\ 0.2988 & 0.5868 & 0.1144 \\ 0 & 0.0661 & 1.1150\end{matrix} ) \\ Rt , Gt , Bt \geq 0 \\ {Rt}^{′} = {( \frac{Rt}{255} )}^{γ} {Gt}^{′} = {( \frac{Gt}{255} )}^{γ} {Bt}^{′} = {( \frac{Bt}{255} )}^{γ} \\ Rt , Gt , Bt < 0 \\ {Rt}^{′} = - {( \frac{- Rt}{255} )}^{γ} {Gt}^{′} = {( \frac{- Gt}{255} )}^{γ} {Bt}^{′} = - {( \frac{- Bt}{255} )}^{γ}\end{matrix} \qquad [ Eq . 2 ]$$

The color space of image data obtained after the matrix operation has been executed is an XYZ color space. The XYZ color space is an absolute color space, and is a device-independent color space not dependent on a device such as a digital still camera or printer. Thus, device-independent color matching can be carried out by means of color space conversion through the agency of the XYZ color space.

Next, in Step S330, CPU 31 performs an operation employing a matrix N⁻¹, and inverse gamma correction to convert image data based on the XYZ color space to image data based on the wRGB color space. During inverse gamma correction, CPU 31 acquires a printer gamma value from PROM 32, and executes inverse gamma correction of the image data using the inverse of the acquired gamma value. CPU 31 then acquires from PROM 32 a matrix N⁻¹ that corresponds to the conversion from the XYZ color space to the wRGB color space, and performs a matrix operation on the image data suing this matrix N⁻¹. This matrix operation may be given by the following arithmetic expression, for example.

$$\begin{matrix}( \begin{matrix}Rw \\ Gw \\ Bw\end{matrix} ) = {N}^{- 1} ( \begin{matrix}X \\ Y \\ Z\end{matrix} ) \\ {N}^{- 1} = ( \begin{matrix}3.30572 & - 1.77561 & 0.73649 \\ - 1.04911 & 2.1694 & - 1.4797 \\ 0.06568289 & - 0.241078 & 1.24898\end{matrix} ) \\ {Rw}^{′} = {( \frac{Rw}{255} )}^{1 / γ} {Gw}^{′} = {( \frac{Gw}{255} )}^{1 / γ} {Bw}^{′} = {( \frac{Bw}{255} )}^{1 / γ}\end{matrix} \\ \qquad [ Eq . 3 ]$$

Next, in Step S340, CPU 31 executes automatic adjustment processing of image quality. Automatic image quality adjustment processing in this embodiment involves automatic image quality adjustment processing of image data using image generation record information contained in the image file GF, particularly the parameter value for flash as supplementary light source flash information. Automatic image quality adjustment processing is described later.

Next, in Step S350, CPU 31 executes a CMYK color conversion process and a halftone process for the purpose of printing. In the CMYK color conversion process, CPU 31 refers to a look-up table (LUT), stored in PROM 32, for conversion from the wRGB color space to the CMYK color space, and converts the color space of the image data from the wRGB color space to the CMYK color space. That is, image data consisting of RGB multi level values is converted to image data for use by printer 20, consisting, for example, of multi level values for six colors, C (Cyan), M (Magenta), Y (Yellow), K (Black), LC (Light Cyan), and LM (Light Magenta).

In the halftone process, CPU 31 executes a so-called halftone process to produce halftone image data from the color-converted image data. This halftone image data is sequenced in the order of transmission to drive buffer 37 (FIG. 7) to produce the final print data, whereupon the processing routine terminates. Image data processed by means of this processing routine is output in Step S250 of the image processing routine shown in FIG. 9.

F. Embodiments of Automatic Image Quality Adjustment Process

### F1. Embodiment 1 of Automatic Image Quality Adjustment Process

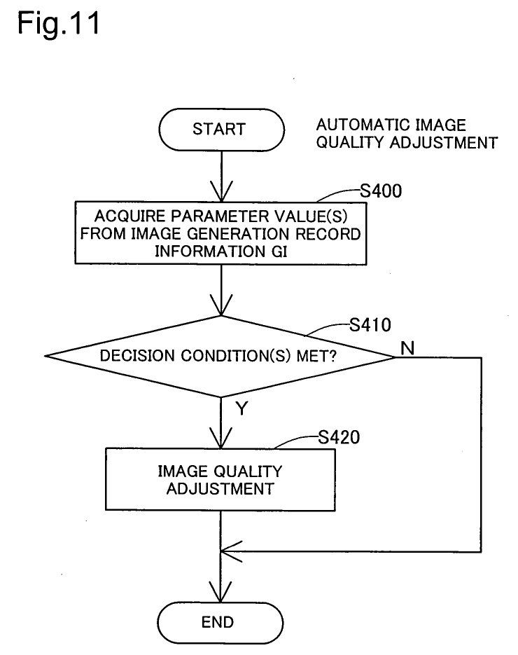

FIG. 11 is a flowchart showing a processing routine for automatic image quality adjustment processing (corresponding to Step S340 in FIG. 10). CPU 31 (FIG. 7) analyzes the image generation record information GI and acquires parameter values for flash information etc. (Step S400). Next, in Step S410, CPU 31, on the basis of the acquired parameter values, makes a decision as to whether to execute image quality adjustment processing (described later in detail. In the event that it is decided to execute image quality adjustment processing (Step S410: Y), in Step S420, CPU 31 executes image quality adjustment processing (described later in detail). In Step S410, in the event that it is decided not to execute image quality adjustment processing (Step S410: N), the routine terminates.

In this embodiment, CPU 31 decides to execute image quality adjustment processing where the following condition is met.

(a1) The flash was fired at the time of image data generation.

The decision regarding condition (a1) is made on the basis of flash information parameter values. In the event that the operation result contained in the flash information is Flash on, CPU 31 decides that condition (a1) has been met. As described previously, in the event that a reflected light sensing mechanism is present and sensed reflected light is absent, it is decided that the condition (a1) is not met, even if the operation result is Flash on. By so doing, image quality adjustment processing can be executed in the event that the flash has fired.

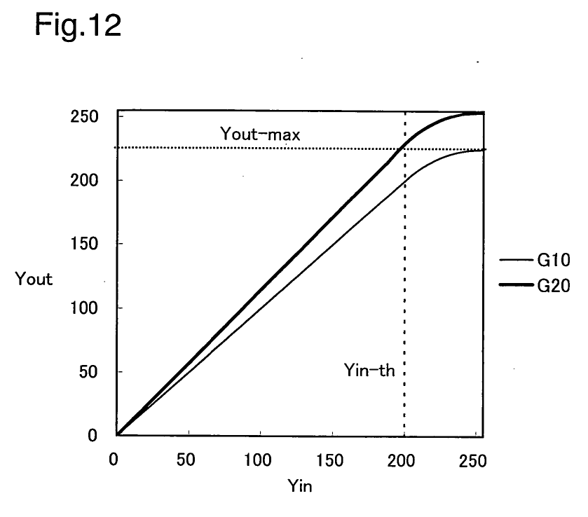

FIG. 12 is an explanatory diagram showing the relationship between brightness value input level Yin and output level Yout in the image quality adjustment process of this embodiment. In this embodiment, the defined area for brightness value is 0-255. In the example of graph G10 shown in FIG. 12, brightness values are adjusted so that where brightness value input level Yin is at the maximum value within its possible range, brightness value output level Yout is a value smaller than the original value Yout-max. Further, the design is such that in the range over which input level is smaller than a predetermined value Yin-th, brightness values are not adjusted; and in the range over which the output level is larger than a predetermined value Yin-th, the proportional increase in output level relative to an increase in input level becomes smaller as the input level becomes greater. By so doing, without changing contrast in areas where brightness values are smaller than a predetermined value Yin-th, brightness values in a whiteout area that is white due to high brightness can be reduced so as to make the whiteout area less standing out. Printers, which are frequently employed as image output devices, are frequently designed so that no ink is ejected onto areas where brightness values have the maximum value within the possible range. Even in such instances, since brightness value output level is adjusted to below maximum value within the possible range, standing out of whiteout areas due to absence of ink ejected thereon can be reduced. Further, where the color space of image data subjected to image quality adjustment processing is a color space that includes brightness as a parameter, for example, where it is a YCbCr color space, image quality adjustment processing can be executed using those brightness values. Where the color space of image data is a color space that does not include brightness as a parameter, for example, where it is an RGB color space, it is preferable to execute image quality adjustment processing after first converting it to a color space that includes brightness as a parameter, for example, a YCbCr color space, HSL color space, or the like. By so doing, adjustment of brightness values can be executed easily. In this case, a process to again restore the original color space is executed after execution of image quality adjustment processing has been completed.

In the example of graph G10, the corresponding relationship over the range in which input level Yin is higher than a predetermined value Yin-th is set so that the proportional change in output level Yout relative to input level Yin is smaller. Accordingly, over the range in which input level is higher than a predetermined value Yin-th, the change in output level Yout is smaller. As a result, the difference in brightness between a whiteout area that is white due to high brightness, and the surrounding area is reduced, so that whiteout areas can be prevented from standing out.

Graph G20 of FIG. 12 is a graph of another example of a corresponding relationship between brightness value input level Yin and output level Yout. The difference with respect to the example of graph G10 is that adjustment of brightness values is executed such that when input level Yin is at the maximum value within its possible range, output level Yout is equal to the original value. In the example of graph G20 as well, a corresponding relationship is established such that, over the range in which input level is higher than a predetermined value Yin-th, the change in output level Yout is small. By adjusting brightness values on the basis of graph G20, change in brightness value of bright image areas having brightness values greater than Yin-th can be minimized without darkening the brightness of the output image, so that whiteout areas can be prevented from standing out.

### F2. Embodiment 2 of Automatic Image Quality Adjustment Process

In this embodiment, CPU 31 (FIG. 7) decides to execute image quality adjustment processing where the following conditions are met.

(a1) The flash was fired at the time of image data generation; and

(b1) subject distance is equal to or less than a first predetermined value.

Condition (a1) is the same as condition (al) in Embodiment 1. The decision regarding condition (b1) is executed on the basis of a parameter value of subject distance information acquired from the image generation record information GI. Whiteout areas are prone to occur when the amount of light on the subject from a supplementary light source exceeds the proper amount. Also, the smaller the subject distance (i.e. the closer it is), the greater the amount of light falling on the subject from the supplementary light source. In this embodiment, where the parameter value of subject distance information is equal to or less than a first predetermined value Lth decided in advance, for example, 2 meters or less, CPU 31 (FIG. 7) decides that condition (b1) is met. In this way, by executing image quality adjustment processing where subject distance is small, whiteout areas occurring due to the subject and image generating device being close together can be prevented from standing out. In this embodiment, the range over which subject distance is equal to or less than the first predetermined value is the first predetermined close range of the invention.

### F3. Embodiment 3 of Automatic Image Quality Adjustment Process

In this embodiment, as in Embodiment 2 described above, CPU 31 (FIG. 7) decides to execute image quality adjustment processing where the following conditions are met.

(a1) The flash was fired at the time of image data generation; and

(b1) subject distance is equal to or less than a first predetermined value.

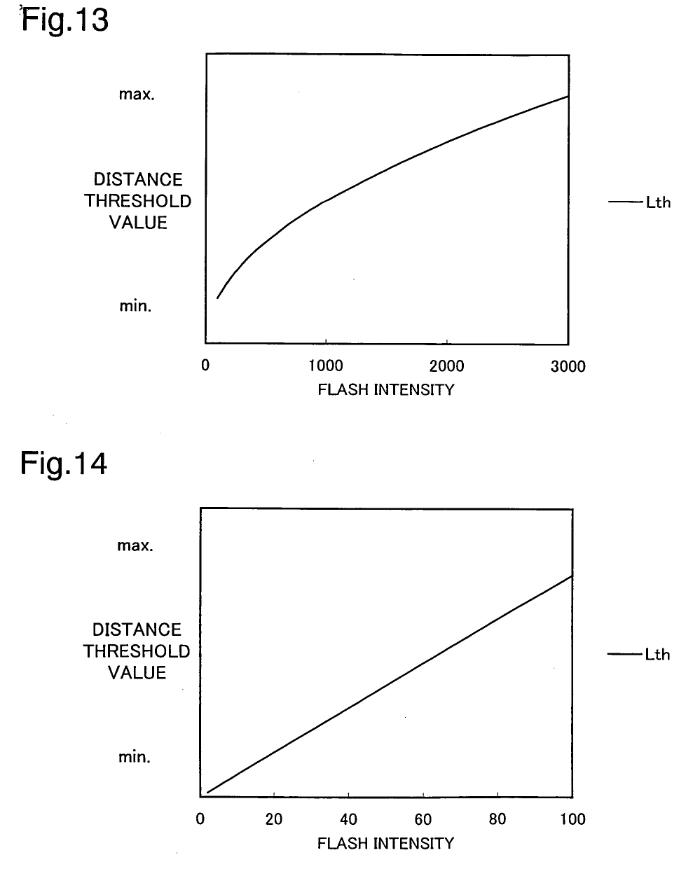

The difference from Embodiment 2 described above is that the first predetermined value Lth, which is the condition (b1) for deciding to execute image quality adjustment processing, is adjusted on the basis of flash intensity. Flash intensity is a parameter value of flash intensity information acquired from image generation record information GI. FIG. 13 is an explanatory diagram showing relationship between first predetermined value Lth and flash intensity in this embodiment. The amount of light falling on a subject from a supplementary light source becomes greater as the flash intensity becomes higher. Thus, the higher flash intensity is, the greater will be the first predetermined value Lth, i.e. the greater or longer will be the threshold value for distance at which whiteout areas are likely to occur. In the embodiment shown in FIG. 13, in consideration of the fact that the amount of light from a supplementary light source falling on the subject is inversely proportional to the square of the subject distance, first predetermined value Lth is proportional to the square root of flash intensity. CPU 31 (FIG. 7) decides that condition (b1) is met when subject distance is equal to or less than first predetermined value Lth which is adjusted on the basis of flash intensity. By so doing, the decision of whether to execute image quality adjustment processing can be executed appropriately on the basis of flash intensity. In this embodiment, the range over which subject distance is equal to or less than the first predetermined value is the first predetermined close range. Also, where the parameter value of flash intensity information is not the quantity of light value emitted by a supplemental light source, but rather a value wherein the quantity of emitted light is represented using an appropriate distance from the subject, for example, where it is a guide number, the first predetermined value Lth will be proportional to flash intensity, as shown in FIG. 14.

### F4. Embodiment 4 of Automatic Image Quality Adjustment Process

In this embodiment, as in Embodiment 2 described previously, CPU 31 (FIG. 7) decides to execute image quality adjustment processing where the following conditions are met.

(a1) The flash was fired at the time of image data generation; and

(b1) subject distance is equal to or less than a first predetermined value.

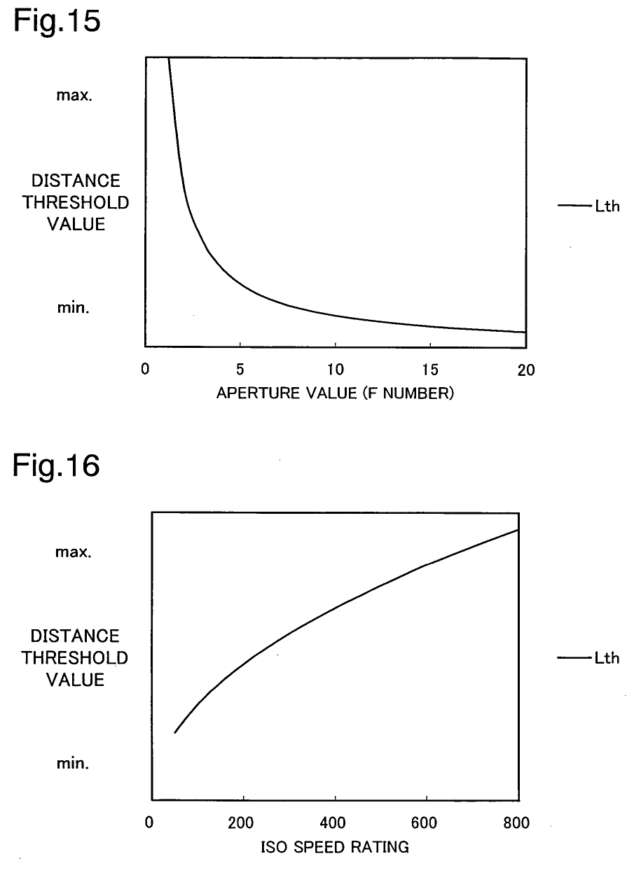

The difference from Embodiment 2 described previously is that the first predetermined value Lth, which is the condition (b1) for deciding to execute image quality adjustment processing, is adjusted on the basis of aperture value (F number). Aperture value (F number) is a parameter value of aperture value information acquired from image generation record information GI. FIG. 15 is an explanatory diagram showing the relationship between first predetermined value Lth and F number in this embodiment. The amount of light received by optical circuit 121 (FIG. 2) of the image generating device becomes less as the F number becomes larger. Thus, the larger the F number, the greater the appropriate amount of light received by the subject from the supplemental light source. That is, the larger the F number, the smaller (shorter) the first predetermined value Lth, i.e., the distance at which whiteout areas are prone to occur. In the embodiment shown in FIG. 15, in consideration of the fact that the amount of light received by the optical circuit of the image generating device is inversely proportional to the square of the F number, and is inversely proportional to the square of the subject distance, first predetermined value Lth is proportional to the F number. By so doing, CPU 31 (FIG. 7) can execute appropriately on the basis of F number the decision of whether to execute image quality adjustment processing.

### F5. Embodiment 5 of Automatic Image Quality Adjustment Process

In this embodiment, as in Embodiment 2 described previously, CPU 31 (FIG. 7) decides to execute image quality adjustment processing where the following conditions are met.

(a1) The flash was fired at the time of image data generation; and

(b1) subject distance is equal to or less than a first predetermined value.

The difference from Embodiment 2 described previously is that the first predetermined value Lth, which is the condition (b1) for deciding to execute image quality adjustment processing, is adjusted on the basis of ISO speed rating. ISO speed rating is a parameter value of ISO speed rating information acquired from image generation record information GI, and is a value wherein an index indicating sensitivity of optical circuit 121 of digital still camera 12 (FIG. 2) is represented using corresponding ISO speed. FIG. 16 is an explanatory diagram showing the relationship between first predetermined value Lth and ISO speed rating in this embodiment. The brightness value of image data generated by means of digital still camera 12 becomes greater as the ISO speed rating (sensitivity) of optical circuit 121 becomes larger. In other words, it may be the also that the apparent quantity of light received by optical circuit 121 can be greater the greater the ISO speed rating. Thus, the greater the speed rating of optical circuit 121, the smaller the appropriate quantity of light received by a subject from the supplemental light source. That is, the greater the ISO speed rating, the greater or longer the first predetermined value Lth, i.e., the distance at which whiteout areas are prone to occur. In the embodiment shown in FIG. 16, in consideration of the fact that brightness value of image data generated by an image generating device, i.e., the apparent quantity of light received by optical circuit 121, is proportional to ISO speed rating, first predetermined value Lth is proportional to the square root of ISO speed rating. By so doing, CPU 31 (FIG. 7) can execute appropriately on the basis of ISO speed rating the decision of whether to execute image quality adjustment processing.

### F6. Embodiment 6 of Automatic Image Quality Adjustment Process

In this embodiment, CPU 31 (FIG. 7) decides to execute image quality adjustment processing where the following conditions are met.

(a1) The flash was fired at the time of image data generation; and

(c1) flash intensity is greater than a second predetermined value.

Condition (a1) is the same as condition (a1) in Embodiment 1. The decision regarding condition (c1) is executed on the basis of a parameter value of flash intensity information acquired from the image generation record information GI. Whiteout areas occur more readily where the quantity of light received by a subject from the supplemental light source exceeds the appropriate quantity. In this embodiment, where the parameter value of flash intensity information exceeds a second predetermined value determined in advance, for example, 1000 BCPS, CPU 31 (FIG. 7) decides that condition (c1) is met. In this way, by executing image quality adjustment processing when flash intensity is high, whiteout areas produced when the quantity of light from the supplemental light source is too great can be prevented from standing out. In this embodiment, the range over which flash intensity is equal to or less than the second predetermined value is the second predetermined range of the invention.

### F7. Embodiment 7 of Automatic Image Quality Adjustment Process

In this embodiment, CPU 31 (FIG. 7) decides to execute image quality adjustment processing where the following conditions are met.

(a1) The flash was fired at the time of image data generation; and

(d1) the maximum value of whiteout area size is greater than a predetermined threshold value.

Condition (a1) is the same as condition (a1) in Embodiment 1. The decision regarding condition (d1) is executed on the basis of maximum value of whiteout area size, obtained by analysis of image data. A whiteout area is an area of linked pixels having brightness values equal to or greater than a first predetermined brightness value. As a first predetermined brightness value, there may be used, for example, a maximum brightness value which is the maximum within the possible range thereof (255 where brightness values are represented on 8 bits). In this case, an area in which maximum brightness pixels whose brightness value is the maximum possible value are linked is used as a whiteout area. A value smaller than maximum brightness value may be used as the first predetermined brightness value. By so doing, in addition to an area of linked maximum brightness pixels, the surrounding area can be used as a whiteout area. The first predetermined brightness value can be determined on the basis of sensitivity evaluation of the output result of the image. For whiteout area size, the number of pixels making up the area can be used.

As a method for deciding whether two pixels A, B are linked, there can be used a method wherein it is decided that they are linked where pixel B is situated within a predetermined distance from pixel A. For example, in image data having pixels arranged in grid form, where the predetermined distance is set to 1.5 pixels, it will be determined that the two pixels are linked where pixel B is situated an any of the eight pixel locations surrounding pixel A.

As a method for dividing a plurality of pixels into areas, there can be used a method wherein a plurality of pixels linked to a common pixel are treated as belonging to the same area, to divide them into areas. By means of this method, one or several whiteout areas can be composed from a plurality of pixels having brightness values equal to or greater than a first predetermined brightness value.

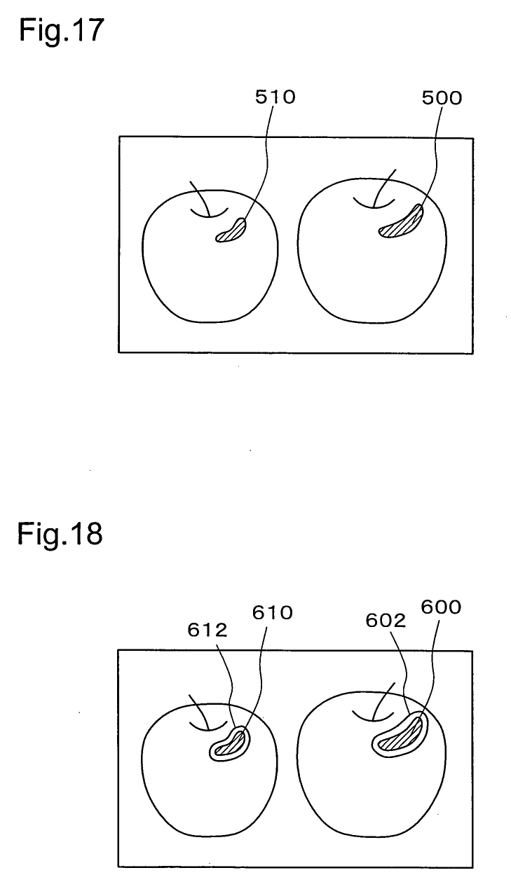

FIG. 17 is an explanatory diagram describing an example of a whiteout area in an image. FIG. 17 is an image in which two fruits are shown; areas of brightness values equal to or greater than a first predetermined brightness value are indicated by hatching. Pixels in the areas indicated by hatching are sorted into two whiteout areas 500 and 510 by the method of dividing into areas described previously. Since whiteout areas 500 and 510 are not linked, they are treated as separate whiteout areas. Where a plurality of whiteout zones are present in this manner, the size of the largest whiteout area is used during the decision regarding condition (d1). In the example shown in FIG. 17, the size of whiteout areas 500 is used, for example.

In this embodiment, where whiteout area size (or where there are a plurality of whiteout zones, the maximum value of size thereof) is greater than a predetermined threshold value, for example, 5% of all pixels, CPU 31 (FIG. 7) decides that condition (d1) is met. By so doing, in the event that a large whiteout area should occur, the area can be prevented from standing out.

In this embodiment, (a1) and (d1) are employed as decision conditions for executing image quality adjustment processing, but an arrangement wherein only (d1) is used is acceptable as well. By so doing, regardless of whether or not there is illumination by the supplemental light source, large whiteout areas can be prevented from standing out. Decision condition (d1) enables decisions to be made without using image generation record information, enabling an arrangement whereby even in standard image processing in the absence of image generation record information (Step S260 in FIG. 9), image quality adjustment processing is executed in the event that decision condition (d1) is met.

### F8. Embodiment 8 of Automatic Image Quality Adjustment Process

In this embodiment, in contrast to the embodiments described previously, pixels targeted for image quality adjustment processing can be selected from a first type area, and a second type area which surrounds the first area. The first type area is a maximum brightness area of linked maximum brightness pixels whose brightness values are the maximum value possible. FIG. 18 is an explanatory diagram describing an example of a first type area and image quality adjustment process target area in an image. In FIG. 18, two first type areas 600 and 610 are shown hatched; image quality adjustment process target areas 602, 612 each including a first type area and a surrounding second type area are also shown. As a second type area, there may be selected, for example, pixels whose shortest distance from a first type area is a first predetermined distance, for example, 5 pixels or less. In this way, by targeting for processing an area that includes a first type area whose brightness value is the maximum possible and a second type area which is the surrounding area thereof, image quality adjustment processing can be executed without changing image quality in areas not including first type areas, and without making the boundary between a maximum brightness first type area and the surrounding area stand out.

As a method for selecting a second type area which surrounds the first type area, there may be used a method of selecting on the basis of brightness value magnitude, rather than distance from a first type area only. For example, an area that is composed of pixels whose brightness values are equal to or greater than a second brightness value close to maximum brightness value, and that is linked to a first type area may be selected as a second type area. By so doing, in areas that are brighter than the second brightness value, a boundary is created between an area targeted for processing and an area not targeted for processing, so that the boundary can be prevented from standing out. The second brightness value can be determined on the basis of sensory test of image output results, so as to optimize image output results. Where brightness value adjustment is carried out on the basis of graph G10 in FIG. 12, Yin-th, i.e., the minimum value of brightness value for adjusting brightness value, can be used as the second predetermined brightness value. By so doing, image quality adjustment processing can be performed without the boundary between an area targeted for processing and an area not targeted for processing standing out. The second predetermined brightness value for determining areas targeted for processing can be the same as the first predetermined brightness value for determining whiteout areas, used in the image quality adjustment processing decision. In this case, whiteout areas will be selected as areas targeted for image quality adjustment processing.

### F9. Embodiment 9 of Automatic Image Quality Adjustment Process

In the preceding embodiments, image quality adjustment processing involving adjustment of brightness value is executed, but additional image quality adjustment processing involving adjustment of hue and/or saturation of areas targeted for processing could be executed. For example, where there is little change in hue in the surrounding area of an area targeted for processing, the hue of the area targeted for processing can be adjusted to the average value of hue for the surrounding area. By so doing, the hue of the area targeted for processing is made to approximate the hue of the surrounding area, thereby further preventing the area targeted for processing from standing out. As regards saturation, it is preferable to adjust it to a value about equal to or smaller than saturation in the surrounding area. As this saturation, the average value or minimum value for saturation in the surrounding area may be used. By so doing, an area targeted for processing can be prevented from being more brightly colored and standing out from the surrounding area.

### F10. Embodiment 10 of Automatic Image Quality Adjustment Process

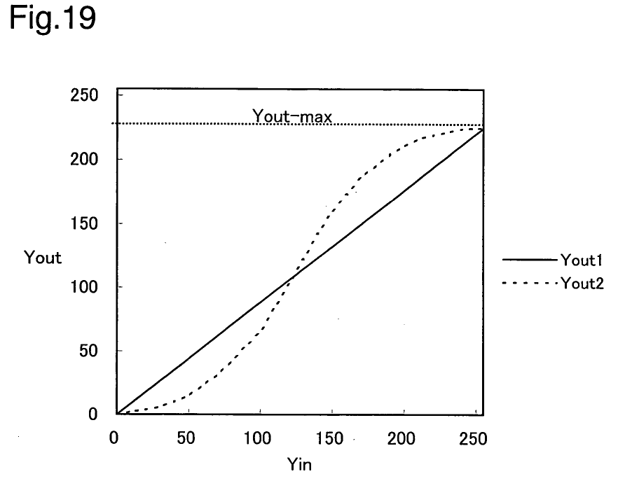

FIG. 19 is an explanatory diagram showing another embodiment of the relationship between brightness value input level Yin and output level Yout in image quality adjustment processing. FIG. 19 shows two embodiments, Yout1 and Yout2. Yout1, in contrast to the embodiment in FIG. 12, is designed so that the proportion of increase in output level relative to an increase in input level is constant regardless of input level. By so doing, change in brightness values in gradation areas wherein brightness value varies appreciably can be represented smoothly. Yout2 is designed so that the proportion of change in output level is large in areas of intermediate input level. By so doing, contrast can be represented more intensely. The relationship between brightness value input level and output level can be determined on the basis of sensory test of image output results, so as to optimize image output results. In any event, adjustment of brightness values is executed such that change in brightness value output level is small over the highest range of possible values for brightness value input level.

Yout1 is also designed such that change in brightness value output level is small over the entire range of possible values for brightness value input level.

### F11. Embodiment 11 of Automatic Image Quality Adjustment Process:

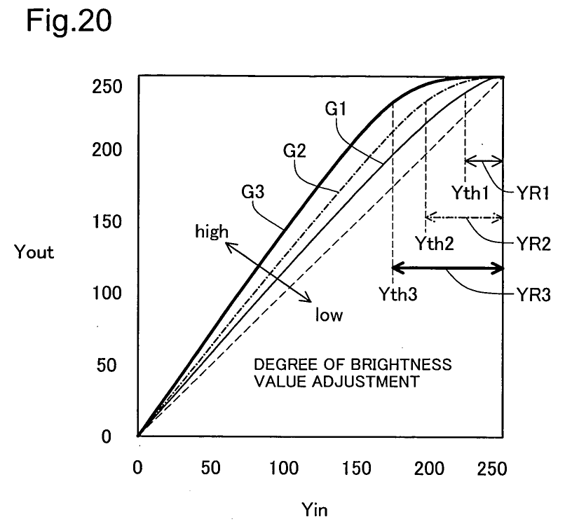

FIG. 20 is an explanatory diagram showing another embodiment of the relationship between brightness value input level and output level in image quality adjustment processing. Graph G1 is designed so that the proportion of increase in output level Yout relative to an increase in input level Yin is smaller over a first range YR1 wherein input level Yin is higher than a first brightness threshold value Yth1. By performing brightness value adjustment using this graph G1, variation in brightness value output level in areas where input level Yin is greater than first brightness threshold value Yth1 can be kept small. As a result, whiteout areas can be prevented from standing out. Graphs G2 and G3 show input/output relationships used in processing with a higher degree of brightness value adjustment than in graph G1. In graph G2, the proportion of increase in output level Yout relative to an increase in input level Yin is smaller over a second range YR2 wherein input level Yin is higher than a second brightness threshold value Yth2. Second brightness threshold value Yth2 is a smaller value than first brightness threshold value Yth1. In graph G3, the proportion of increase in output level Yout is smaller over a third range YR3 higher than a third brightness threshold value Yth3 which is smaller than second brightness threshold value Yth2. By adopting a wider range of brightness values over which the proportion of increase in output level is small, differences in brightness value from whiteout areas can be minimized over a wider image area, whereby whiteout areas can be made even less likely to stand out. In this way, the size of the highest range of possible values for brightness value input level, over which range which the proportion of increase in output level is small, can be used as an index showing the degree of brightness value adjustment.

The degree of brightness value adjustment is preferably set higher as the amount of light received by a subject becomes larger. For example, it may be designed to increase with an increase in flash intensity. Or, it may be designed to decrease with an increase in aperture value or with an increase in subject distance, or to increase with an increase in ISO speed rating. In this way, by adjusting the degree of brightness value adjustment on the basis of image generation record information, image quality adjustment processing more suited to image data generated under various conditions can be executed without excessive adjustment of brightness value. In any event, adjustment of brightness values is executed such that change in brightness value output level is small over the highest range of possible values for brightness value input level.

### G. Arrangement of Image Output System Employing Image data Processing Device

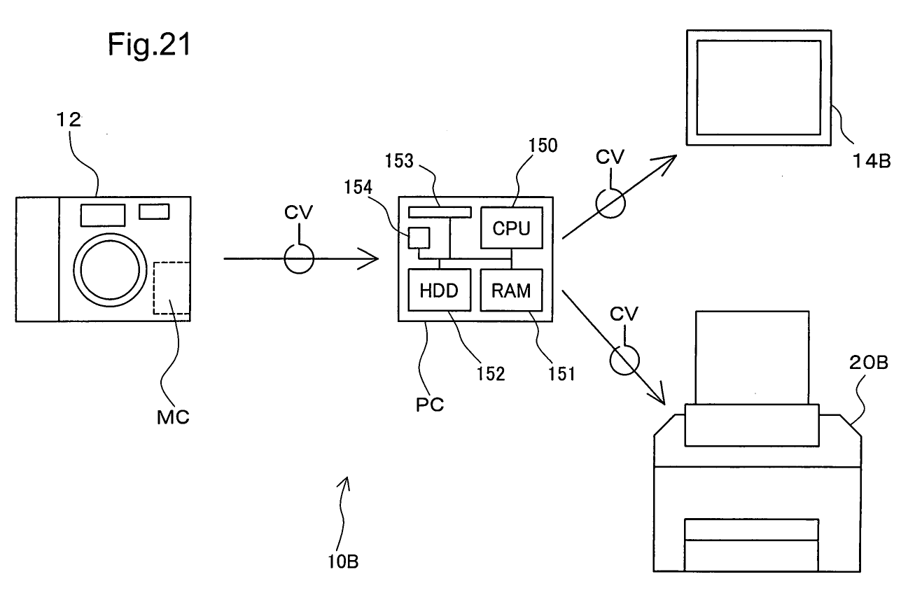

FIG. 21 is an explanatory diagram showing an example of an image output system in which an image data processing device may be implemented by way of an embodiment of the present invention. Image output system 10B comprises a digital still camera 12 as an image generating device for generating image files; a computer PC for executing image quality adjustment processing based on a image file; and a printer 20B as an image output device for outputting images. Computer PC is computer of commonly used type, and functions as a image data processing device (or image processing device). As the output device, a CRT display, LCD display, or other monitor 14B, or a projector or the like could be used instead of printer 20B. In the following description, it is assumed that printer 20B is used as the image output device. This embodiment differs from the image output system embodiment described previously (FIG. 1) in that the image data processing device having an image quality adjuster, and the image output device equipped having an image output section are constituted independently. The computer PC serving as the image data processing device and the printer having an image output section can be termed an “output device” in the broad sense.

A image file created in digital still camera 12 is transferred to computer PC via a cable CV, or by directly inserting into computer PC a memory card MC having the image file stored thereon. Computer PC executes image quality adjustment processing of the image data based on the read out image file. The image data produced by image quality adjustment processing is transferred to printer 20B via a cable CV, and output by printer 20B.

Computer PC comprises a CPU 150 for executing a program that realizes the aforementioned image quality adjustment processing; RAM 151 for temporarily storing results of operations by CPU 150, image data, and the like; and a hard disk drive (HDD) 152 for storing data needed for image quality adjustment processing, such as an image quality adjustment processing program, lookup tables, aperture value tables, and the like. CPU 150, RAM 151, and HDD 152 function as an image quality adjuster. Computer PC further comprises a memory card slot 153 for installing a memory card MC; and an input/output terminal 154 for connecting a connector cable from digital still camera 12 or the like.

A image file GF generated by a digital still camera 12 is supplied to computer PC via a cable or via a memory card MC. When a image data processing application program, either an image retouching application or a printer driver, is started up by user control, CPU 150 executes an image processing routine (FIG. 9) to process the read in image file GF. Alternatively, the image data processing application program may be set to start up automatically when a memory card MC is inserted into memory card slot 153, or when connection of a digital still camera 12 to input/output terminal 154 via a cable is detected.

Image data processed by CPU 150, rather than being output in Step S250 of the image processing routine (FIG. 9), is instead transferred to an image output device, for example, printer 20B, whereupon the image output device receiving the image data executes image output.

At this time, the image-processed image data is transferred by CPU 150 to printer 20B as the image output section. In this embodiment, CPU 150 functions as a “data output section”.

In this embodiment, image processing is carried out using an image quality adjuster provided to computer PC, so it is possible to use an image output device that does not have an image quality adjuster. Where the image output device is provided with an image quality adjuster, image data may be output to the image output device without being subjected to image processing on computer PC, and image processing instead carried out by the image quality adjuster of the image output device. Alternatively, where the image generating device is provided with an image quality adjuster, image processing may be carried out by the image quality adjuster of the image generating device, and image data having been processed by the image generating device then transferred directly to the image output device, whereupon the image output device executes image output in response to the received image data.

As described hereinabove, in the preceding embodiments, image quality of images in which whiteout areas have occurred can be adjusted automatically, so output results of high quality can be obtained with ease.

The invention is not limited to the embodiments set forth hereinabove, and may be reduced to practice in various modes without departing from the scope and spirit thereof; the following variations are possible, for example.

### H. VARIANT EXAMPLES

### H1. Variant Example 1

In the embodiments hereinabove, the first predetermined value which is the decision condition (b1) for executing image quality adjustment processing may be adjusted on the basis of a plurality of parameter values. For example, an arrangement in which adjustment is made on the basis of flash intensity and aperture value (F number) can be made. An arrangement in which parameter values for use in adjusting the first predetermined value is selected based on types of information included in image generation record information GI can be made as well. For example, where image generation record information GI includes flash intensity and ISO speed rating, an arrangement can be made whereby the first predetermined value is adjusted on the basis of flash intensity and ISO speed rating; and where flash intensity and aperture value are included, whereby the first predetermined value is adjusted on the basis of flash intensity and aperture value. In this way, more appropriate decisions can be executed by selecting decision conditions based on information included in image generation record information GI.

### H2. Variant Example 2

An arrangement whereby decision conditions for executing image quality adjustment processing are selected for use among a plurality of decision conditions based on information included in image generation record information GI can also be made. For example, where image generation record information GI includes flash information, subject distance information, and aperture value information, an arrangement whereby decisions are executed on the basis of decision conditions (a1), (b1), and (d1), or where only flash information is included, decisions are executed on the basis of decision conditions (a1) and (d1), may also be made. In this way, more appropriate decisions can be executed by selecting decision conditions based on information included in image generation record information GI.

### H3. Variant Example 3

As information relating to the distance between a subject and the image generating device, employed as aforementioned decision condition (b1), distance information other than subject distance information, but that enables a distance range to be set as a parameter value, can be used instead. For example, the decision regarding condition (b1) can be made using subject distance range information set by selecting from among three distance ranges, macro (0-1 m), close-up (1-3 m), or landscape (3 m+). In this case, the decision regarding condition (b1) can be made by pre-establishing typical distance for each of the distance ranges, and comparing the typical distance with a first predetermined value of condition (b1). As a typical distance, for example, for a distance range having an upper limit value and a lower limit value established for distance, the intermediate value could be used; and for a distance range having only an upper limit value or a lower limit value established, the upper limit value or lower limit value could be used. Similarly, an arrangement whereby the degree of brightness value adjustment is adjusted on the basis of subject distance range could be made.

### H4. Variant Example 4

Where generation of image data was performed with a supplemental light source situated apart from the image generating device, it is preferable to execute the decision regarding execution of image quality adjustment processing on the basis of information relating to the distance between the supplemental light source and the subject. As a method for deciding based on the distance between the supplemental light source and the subject, there can be used a method whereby, for example, in condition (b1) in the preceding embodiments, decisions are made using the distance between supplemental light source and subject, instead of subject distance. By so doing, whiteout areas occurring due to short distance between supplemental light source and subject can be prevented from standing out. Similarly, an arrangement whereby the degree of brightness value adjustment is adjusted on the basis of between supplemental light source and subject could be made.

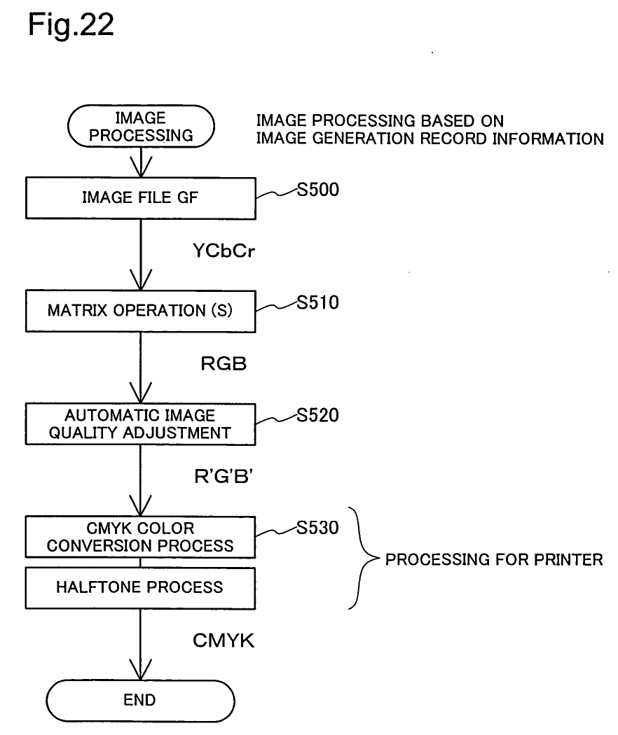

### H5. Variant Example 5

Where a image file GF does not include image data gamma value or color space information, the color space conversion process of the image processing routine shown in FIG. 10 (Step S320 and Step S330) can be omitted. FIG. 22 is a flow chart showing an image processing routine from which the color space conversion process has been omitted. Image data acquired in Step S500 is converted from image data based on a YCbCr color space to data based on an RGB color space in Step S510. Next, in Step S520, automatic image quality adjustment processing is executed using the image data obtained in Step S510. Next, in Step S530, a CYMK conversion process and halftone process for printing are executed.

### H6. Variant Example 6

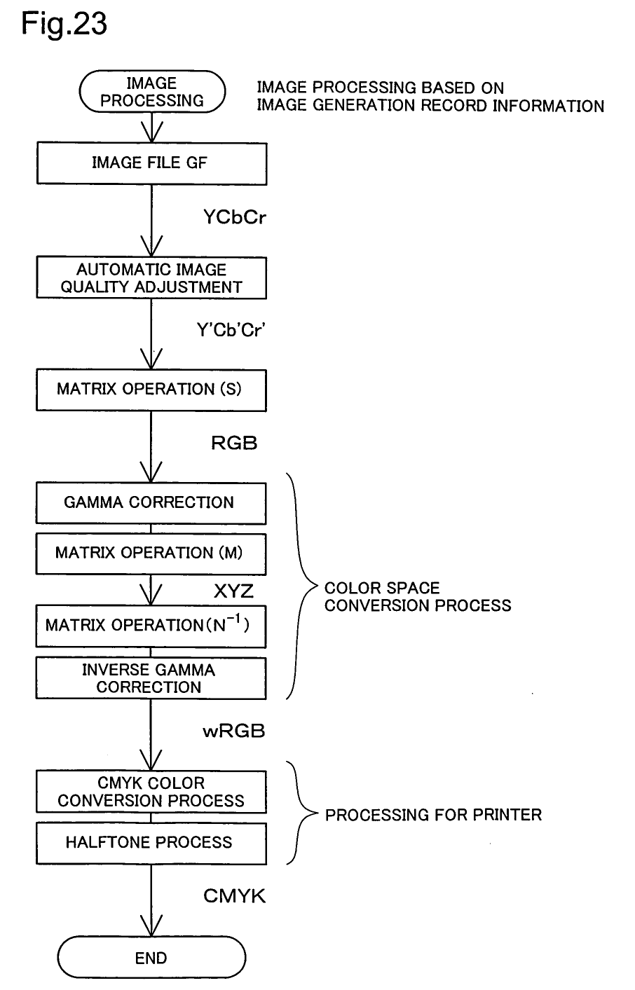

In the preceding embodiments, automatic image quality adjustment processing is executed after executing color space conversion, but instead color space conversion could be executed after executing automatic image quality adjustment processing. For example, image processing could be executed according to the flowchart shown in FIG. 23.

### H7. Variant Example 7

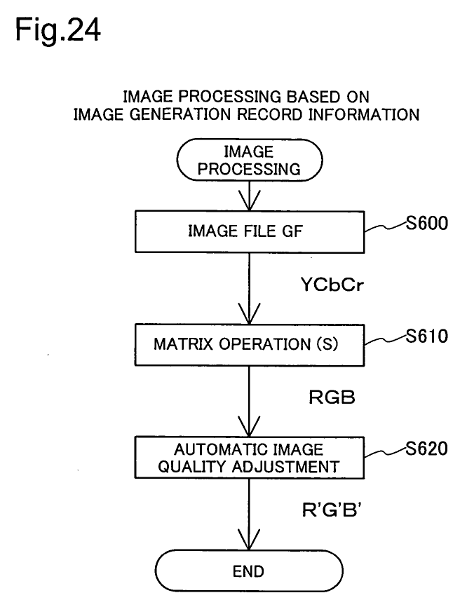

In the preceding embodiments, a printer is used as the image output section, but an image output section other than a printer could be used instead. FIG. 24 is a flowchart showing a processing routine for image processing based on image generation record information where a CRT is used as the image output section. In contrast to the flowchart in FIG. 10 which depicts the use of a printer as the image output section, the CYMK conversion process and halftone process for printing are omitted. Also, since a CRT can represent an RGB color space of image data obtained by executing a matrix operation (S), the color space conversion process is omitted as well. Where image data based on an RGB color space obtained in Step S610 includes data outside the defined area of the RGB color space, the out-of-defined-area data is clipped, and then step S620 is executed. Where the color space utilizable by an image output section is different from an RGB color space, a color conversion process to a color space utilizable by the image output section is executed in a manner analogous to executing a CMYK color conversion process where a printer is used, and the resultant image is output by the image output section.

### H8. Variant Example 8

In the preceding embodiments, the description was made taking an Exif format file as a specific example of the image file GF, but the format of the image file pertaining to the present invention is not limited to this. That is, any image file containing image data generated by an image generating device, and image generation record information GI describing conditions (or information) at the time of generation of the image data is acceptable. With such a file, image quality of image data generated by an image generating device can be appropriately adjusted automatically and output from an output device.

### H9. Variant Example 9

Values of matrices S, N⁻¹, and M in the equations are merely exemplary, and can be modified appropriately depending on color space on which the image file is based, color space utilizable by an image output section, or the like.

### H10. Variant Example 10

In the preceding embodiments, the description was of using a digital still camera 12 as the image generating device, but image files could be generated using a different image generating device, such as a scanner, digital video camera, or the like.

### H11. Variant Example 11

In the preceding embodiments, the description took the example of a case where image data GD and image generation record information GI are contained in the same image file GF, but image data GD and image generation record information GI need not necessarily be stored within the same file. That is, it is sufficient for image data GD and image generation record information GI to be associated with each other; for example, it would be acceptable to generate associating data that associates image data GD with image generation record information GI; store one or several sets of image data and image generation record information GI in independent files; and refer to the associated image generation record information GI when processing the image data GD. This is because, in this case, although the image data GD and image generation record information GI are stored in separate files, at the point in time of image processing which utilizes the image generation record information GI, the image data GD and image generation record information GI are in inseparably linked, and thus function substantially the same as if they were stored in the same file. That is, the term image file GF in the present embodiment includes those of a form wherein image data GD and image generation record information GI are associated, at least at the point in time that image processing takes place. Also included are motion video files stored on optical disk media such as CD-ROM, CD-R, DVD-ROM, DVD-RAM, and the like.

### H12. Variant Example 12

In the preceding embodiments, the digital still camera 12 may execute automatic image quality adjustment processing. For example, in the digital still camera 12 shown in FIG. 2, image processing circuit 123 may be designed to execute automatic image quality adjustment processing. Specifically, image processing circuit 123 executes automatic image quality adjustment processing on image data acquired by means of optical circuit 121 and image acquisition circuit 122. At this time, image processing circuit 123 can use information relating to various shooting conditions (flash mode, etc.) when image data is acquired by circuit 121 and image acquisition circuit 122. Control circuit 124 outputs quality-adjusted image data to liquid crystal display 127, and liquid crystal display 127 displays an image in response to the received image data. In this variant example, image processing circuit 123 corresponds to the “image quality adjuster”. Liquid crystal display 127 functions as the “image output section”, and control circuit 124 functions as the “data output section”. At this time, quality-adjusted image data is preferably stored on a memory card MC. By so doing, even if an output device lacking an image quality adjuster is used, quality-adjusted images can be output. Also, an arrangement wherein digital still camera 12 and an output device serving as the image output section are connected by a cable or by wireless communication, and control circuit of digital still camera 12 transfers quality-adjusted image data to the output device is also acceptable.

### H13. Variant Example 13

In Embodiment 2 of Automatic Image Quality Adjustment Process hereinabove, another arrangement whereby even if condition (a1) “the flash was fired at the time of image data generation” is met, in the event that condition (b1) “distance is equal to or less than a first predetermined value” is not met, image quality adjustment processing is not executed, and instead of this, the degree of brightness value adjustment is reduced to execute image quality adjustment processing with a smaller degree of brightness value adjustment than when condition (b1) is met is acceptable as well. Even where condition (b1) is not met, if condition (a1) is met, there is a possibility, albeit less than when condition (b1) is met, that whiteout areas will occur. Accordingly, by executing brightness value adjustment to a reduced degree, the tendency of whiteout areas to stand out can be minimized without excessive adjustment of brightness value. Similarly, in the above-described Embodiment 6, in the event that condition (a1) is met but condition (c1) “flash intensity is greater than a second predetermined value” is not met, the degree of brightness value adjustment can be reduced as compared to the case where condition cl is met; and in the above-described Embodiment 7, in the event that condition (a1) is met but condition (d1) “the maximum value of whiteout area size is greater than a predetermined threshold value” is not met, the degree of brightness value adjustment can be reduced as compared to the case where condition (d1) is met. By so doing, event where condition (c1) or (d1) is not met, whiteout areas can be prevented from standing out, without excessive adjustment of brightness value.

While the present invention has been described in detail and shown hereinabove, these are given by way of example, and is not limited to these, the spirit and scope of the invention being limited only by the appended claims.

1. A method of performing image processing using image data generated by an image generator and image generation record information that is associated with the image data and that includes at least supplementary light source flash information at the time of generation of the image data, the method comprising the steps of:
judging whether to execute image quality adjustment processing on the basis of the supplementary light source flash information contained in the image generation record information; and
when it is judged to execute the image quality adjustment processing, executing the image quality adjustment processing to adjust the image data such that variation in brightness values is minimized in a highest value range within an entire possible range for brightness values represented by the image data.

2. A method according to claim 1 wherein the image quality adjustment step includes the steps of:
judging, on the basis of the supplementary light source flash information contained in the image generation record information, whether there was illumination by the supplemental light source at the time of generation of the image data is made, and
executing the image quality adjustment processing when a judgment (a) to the effect that “there was illumination by the supplemental light source at the time of generation of the image data” is realized.

3. A method according to claim 2 wherein the image generation record information further includes information relating to a distance between a subject and the image generator of the image data at the time of generation of the image data, and
the image quality adjustment step includes a step wherein
regardless of realization of the judgment (a), when a judgment (b) to the effect that “the distance from the subject is not within a first predetermined close range” is realized, execution of the image quality adjustment processing is halted, or a degree of brightness value adjustment in the image quality adjustment processing is reduced.

4. A method according to claim 3 wherein the image generation record information further includes information relating to quantity of light of the supplemental light source at the time of generation of the image data, and
the image quality adjustment step includes a step of adjusting the first predetermined close range at least on the basis of the quantity of light.

5. A method according to claim 3 wherein the image generation record information further includes information relating to aperture value of the image generator at the time of generation of the image data, and
the image quality adjustment step includes a step of adjusting the first predetermined close range at least on the basis of the aperture value.

6. A method according to claim 3 wherein the image generation record information further includes information relating to sensitivity of an optical circuit of the image generator at the time of generation of the image data, and
the image quality adjustment step includes a step of adjusting the first predetermined close range at least on the basis of the optical circuit sensitivity.

7. A method according to claim 2 wherein the image generation record information further includes information relating to quantity of light of the supplemental light source at the time of generation of the image data, and
the image quality adjustment step includes a step wherein regardless of realization of the judgment (a), when a judgment (c) to the effect that “the quantity of light is not within a second predetermined range”is realized, execution of the image quality adjustment processing is halted, or a degree of brightness value adjustment in the image quality adjustment processing is reduced.

8. A method according to claim 2 wherein the image quality adjustment step includes a step wherein regardless of realization of the judgment (a), when a judgment (d) to the effect that “size of an area of linked pixels having brightness above a first predetermined brightness value in the image data is larger than a predetermined threshold value” is realized, execution of the image quality adjustment processing is halted, or a degree of brightness value adjustment in the image quality adjustment processing is reduced.

9. A method according to claim 1 wherein the image generation record information further contains information relating to quantity of light of the supplemental light source at the time of generation of the image data, and
the image quality adjustment step includes a step of adjusting a degree of brightness value adjustment in the image quality adjustment processing at least on the basis of the quantity of light.

10. A method according to claim 1 wherein the image generation record information further contains information relating to a distance between a subject and the image generator at the time of generation of the image data, and
the image quality adjustment step includes a step of adjusting a degree of brightness value adjustment in the image quality adjustment processing at least on the basis of distance from the subject.

11. A method according to claim 1 wherein the image generation record information further includes information relating to aperture value of the image generator at the time of generation of the image data, and
the image quality adjustment step includes a step of adjusting a degree of brightness value adjustment in the image quality adjustment processing at least on the basis of the aperture value.

12. A method according to claim 1 wherein the image generation record information further includes information relating to sensitivity of an optical circuit of the image generator at the time of generation of the image data, and
the image quality adjustment step includes a step of adjusting a degree of brightness value adjustment in the image quality adjustment processing at least on the basis of the sensitivity.

13. A method according to claim 1 wherein a target area of processing targeted for the image quality adjustment processing includes a first type area of linked maximum brightness pixels having maximum possible brightness value.

14. A method according to claim 13 wherein a target area of processing targeted for the image quality adjustment processing further includes a second type area meeting a specific condition, situated in the vicinity of the first type area.

15. A method according to claim 14 wherein the specific condition includes at least a condition (e) to the effect that “the area is composed of pixels whose shortest distance from the first type area is equal to or less than a first predetermined distance”.

16. A method according to claim 14 wherein the specific condition includes at least a condition (f) to the effect that “the area is an area composed of pixels whose brightness value is equal to or greater than a second predetermined brightness value, and is an area linked to the first area”.

17. A method for performing image processing using image data generated by an image generator, the method comprising the steps of:
judging whether a size of an area of linked pixels having brightness above a first predetermined brightness value in the image data is larger than a predetermined threshold value, and
when the judgment is realized, executing image quality adjustment processing to adjust the image data such that variation in brightness values is minimized in a highest value range within an entire possible range for brightness values represented by the image data.

18. A method according to claim 17 wherein a target area of processing targeted for the image quality adjustment processing includes a first type area of linked maximum brightness pixels whose brightness value is maximum possible brightness value.

19. A method according to claim 18 wherein a target area of processing targeted for the image quality adjustment processing further includes a second type area meeting a specific condition, situated in the vicinity of the first type area.

20. A method according to claim 19 wherein the specific condition includes at least a condition (e) to the effect that “the area is composed of pixels whose shortest distance from the first area is equal to or less than a first predetermined distance”.

21. A method according to claim 19 wherein the specific condition includes at least a condition (f) to the effect that “the area is an area composed of pixels whose brightness value is equal to or greater than a second predetermined brightness value, and is an area linked to the first type area”.

22. An image processing device for performing image processing using image data generated by an image generator and image generation record information that is associated with the image data and that includes at least flash information for a supplementary light source at the time of generation of the image data, the image processing device comprises:
an image quality adjuster that, on the basis of flash information for the supplementary light source included in the image generation record information, makes a judgment as to whether to execute image quality adjustment processing; and when it is judged to execute the image quality adjustment processing, executes image quality adjustment processing to adjust the image data such that variation in brightness value is minimized in a highest value range within an entire possible range for brightness value represented by the image data.

23. An image processing device for performing image processing using image data generated by an image generator, the image processing device comprises:
an image quality adjuster that, when a judgment that a size of an area of linked pixels having brightness above a first predetermined brightness value in the image data is larger than a predetermined threshold value is realized, executes image quality adjustment processing to adjust the image data such that variation in brightness value is minimized in a highest value range within an entire possible range for brightness value represented by the image data.

24. A computer program product for causing a computer to execute a image data process using image data generated by an image generator and image generation record information that is associated with the image data and that includes at least flash information for a supplementary light source at the time of generation of the image data, the computer program product comprising:
a computer-readable medium; and
a computer program stored on the computer-readable medium, the computer program comprising:
a first program for causing a computer to judge, on the basis of flash information for the supplementary light source included in the image generation record information, whether to execute image quality adjustment processing; and
a second program for causing the computer to adjust the image data such that variation in brightness value is minimized in a highest value range within an entire possible range for brightness value represented by the image data, in the event that it is judged to execute image quality adjustment processing.

25. A computer program product for causing a computer to execute a image data process using image data generated by an image generator, the computer program product comprising:
a computer-readable medium; and
a computer program stored on the computer-readable medium, the computer program comprising a program that, when a judgment that a size of an area of linked pixels having brightness above a first predetermined brightness value in the image data is larger than a predetermined threshold value is realized, executes image quality adjustment processing to adjust the image data such that variation in brightness value is minimized in a highest value range within an entire possible range for brightness value represented by the image data.
